(19) United States
(12) Patent Application Publication
(10) Pub. No.: US 2007/0295699 A1
(43) Pub. Date: Dec. 27, 2007

(54) Multi-level welding position controller

(76) Inventors: Mark Ulrich, New London, WI (US); John H. Pilarski, Milwaukee, WI (US)

Correspondence Address: FLETCHER YODER (ILLINOIS TOOL WORKS INC.), P.O. BOX 692289, HOUSTON, TX, 77269-2289, US

(21) Appl. No.: 11/475,283

(22) Filed: Jun. 27, 2006

(51) Int. Cl. B23K 9/20

(52) U.S. Cl. 219/98

(57) ABSTRACT

A system having a power source and a welding stud positioning controller configured to cooperate with the power source to output first, second, and third current levels one after another to a welding stud positioning device. In some embodiments, the welding stud controller may be coupled to the power source, and the first, second, and third current levels may be different from one another.

### BACKGROUND

The present invention relates generally to welding devices and, in certain embodiments, to welding devices having a multi-level position controller.

Electric welding systems typically employ an electrode and a power source to weld a workpiece. Generally, the workpiece is connected to a first lead of the power source and the electrode is connected to a second, differently charged lead of the power source. To initiate welding, the electrode is typically brought near the workpiece, and an electric arc is struck over an air gap between the electrode and the workpiece. The electric arc converts electric energy into thermal energy, which liquefies metal proximate the electrode. In some forms of welding, the electric arc also melts metal in the electrode, thereby consuming the electrode.

In certain types of welding, the electrode is spaced away from the workpiece by an electrode positioning device, such as a solenoid. Typically, the welding system drives a current through the solenoid to lift the electrode and hold the electrode in spaced relation to the workpiece. The current through the solenoid is typically a different current from the welding current that forms the arc.

Heat generated by the solenoid may limit use of the welding system. Mechanical forces associated with initiating movement of the electrode may be relatively large, and the current through the solenoid may be relatively large to generate a strong electromotive force and overcome these forces. Generally, the current through the solenoid is typically of constant magnitude during both the period in which movement of the electrode is initiated and the period in which the electrode is held in a lifted position. Often, maintaining this large current when the electrode is held in a lifted position contributes to overheating of the welding system, thereby limiting use of the welding system while it cools.

### BRIEF DESCRIPTION

The following discussion describes, among other things, a system having a power source and a welding stud positioning controller configured to cooperate with the power source to output first, second, and third current levels one after another to a welding stud positioning device. In some embodiments, the welding stud controller may be coupled to the power source, and the first, second, and third current levels may be different from one another.

### DRAWINGS

These and other features, aspects, and advantages of the present invention will become better understood when the following detailed description is read with reference to the accompanying drawings in which like characters represent like parts throughout the drawings, wherein:

FIG. 1 is perspective view of an exemplary welding system in accordance with an embodiment of the present technique;

FIG. 2 is a partially cut-away, side view illustration of an exemplary stud welding gun in accordance with an embodiment of the present technique;

FIGS. 3-6 are diagrammatical illustrations of an exemplary stud welding process in accordance with an embodiment of the present technique;

FIG. 7 is a diagrammatic representation of the exemplary welding system of FIG. 1 in accordance with an embodiment of the present technique;

FIG. 8 is a current trace of the exemplary welding system of FIG. 1 in accordance with an embodiment of the present technique; and

FIG. 9 is a flowchart depicting an exemplary welding process in accordance with an embodiment of the present technique.

### DETAILED DESCRIPTION

As discussed in detail below, some of the embodiments of the present technique provide a method and apparatus for reducing the amount of heat generated within a stud welding gun. Of course, such embodiments are merely exemplary of the present technique, and the appended claims should not be viewed as limited to those embodiments. Indeed, the present technique is applicable to a wide variety of systems.

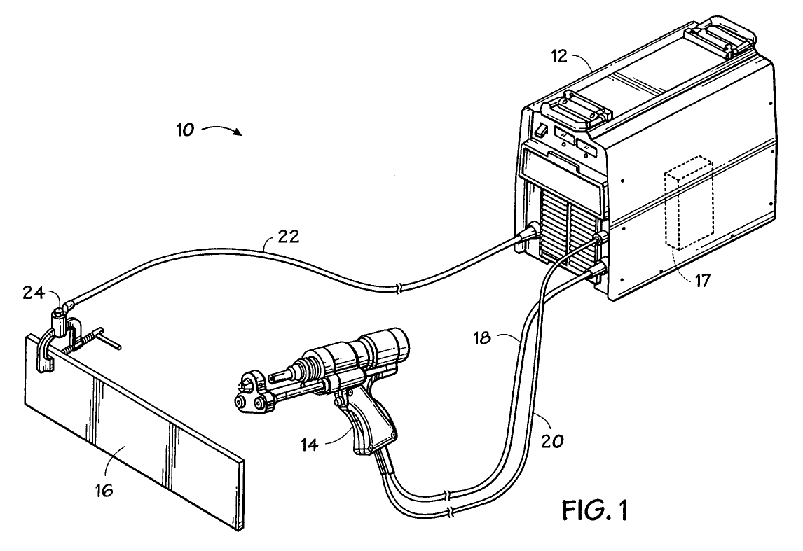

FIG. 1 depicts an exemplary welding system 10. The present exemplary welding system 10 includes a stud welding power control unit 12 (hereinafter “power control unit”), a stud welding gun 14, and a workpiece 16. The present stud welding gun 14 includes a stud drive 15, and the illustrated power control unit 12 may include electronics 17. As explained below, in some embodiments, the power control unit 12 may power a stud drive 15 in a manner that generates relatively little heat. For example, in certain embodiments, the power control unit 12 may output a short burst of power to initiate movement of the stud drive 15 and then output a longer, lower power pulse to hold the stud drive 15 in a position. In other words, the rate of heat generation within the stud drive 15 may be decreased after the stud drive 15 overcomes certain inertial and static friction forces associated with initiating movement. Advantageously, by reducing the power output to the stud drive 15 after initiating movement, the stud welding gun 14 may run cooler in certain embodiments as the period of high power operation is relatively short. The power control unit 12 may, in some embodiments, include electronics 17 to perform some of these functions, such as a welding stud positioning controller, a direct current power source, a welding current control, and/or an insulated gate bipolar transistor (IGBT), for instance.

In the present embodiment, the exemplary welding system 10 includes a weld cable 18, a control cable 20, a ground cable 22, and a clamp 24. While the present weld cable 18 and control cable 20 are depicted as separate cables, in some embodiments the cables 18 and 20 may be bundled or split into additional cables. The present welding system 10 may also include an automatic stud loading system, a factory automation system, and a stud gun positioning system, for example.

When the exemplary welding system 10 is assembled, a welding current circuit and a positioning current circuit may be formed, as is explained in greater detail below. To complete the welding current circuit, the weld cable 18 may electrically couple the stud welding gun 14 to the power control unit 12. The power control unit 12 may electrically connect to the workpiece 16 through the ground cable 22, which may be removably coupled to the workpiece 16 by the clamp 24. Together, in the present embodiment, these components may complete an exemplary welding current circuit. To form the positioning current circuit, the control cable 20 may connect the stud drive 15 to the power control unit 12. As explained below, this circuit may energize the stud drive 15 and position a stud above a workpiece 16. In the present embodiment, the welding current circuit and the positioning current circuit are electrically independent. That is, in this embodiment, the welding current circuit is not used to position a stud, and the positioning current circuit is not used to weld the stud. Of course, other embodiments in accordance with the present technique may integrate these circuits, for example with a current divider in the stud welding gun 14 or time division multiplexing of positioning and welding currents.

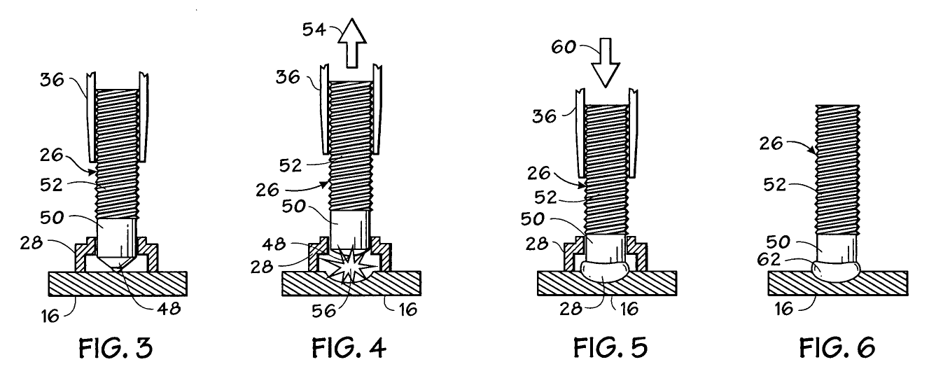

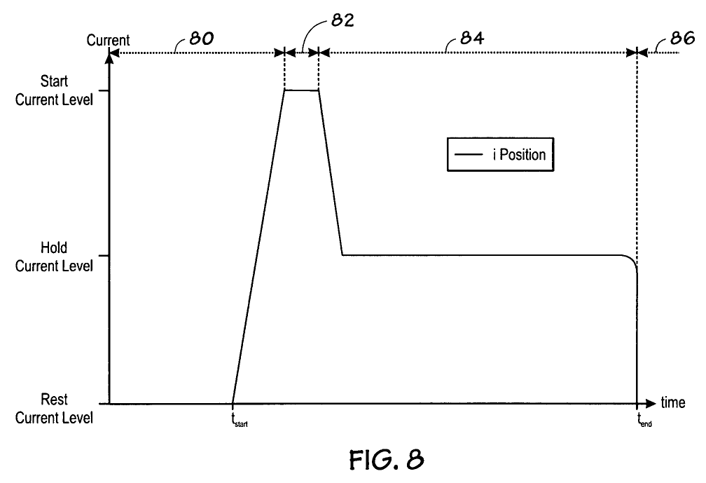

In operation, the welding system 10 may be used to weld a stud to the workpiece 16. As is explained in reference to FIGS. 3-6, the stud welding gun 14 may position a stud on the workpiece 16. After a trigger is pulled, the power control unit 12 may deliver the positioning current, and the present stud drive 15 may lift the stud a short distance from the workpiece 16. In some embodiments, the power control unit 12 may shape the waveform of the positioning current to reduce heat generation in the stud drive 15, as subsequently discussed in reference to FIG. 8. For instance, in some embodiments, the power control unit 12 may initiate movement of the stud drive 15 by outputting a first power level and then output a second, lower power level to hold the stud drive 15 in a position. As explained below, the lower power level may generate less heat in the stud drive 15. After the stud separates from the workpiece 16, in certain embodiments, the power control unit 12 may drive the welding current through the stud. The welding current may arc between the workpiece 16 and the stud, thereby melting metal in the stud and/or the workpiece 16. The ground cable 22 may conduct welding current between the workpiece 16 and the power control unit 12 through the clamp 24. After arcing is complete, the power control unit 12 may stop delivering the lower power positioning current, and the stud drive 15 may plunge the stud into the molten metal, thereby securing the stud to the workpiece 16.

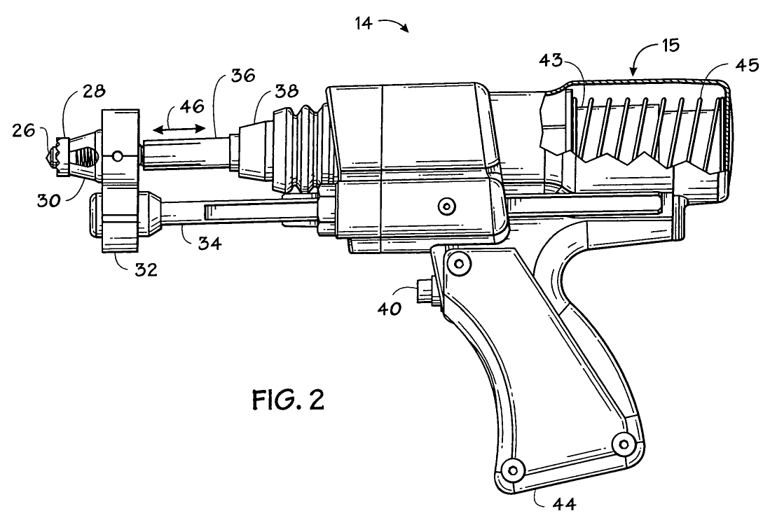

FIG. 2 depicts the exemplary stud welding gun 14 in greater detail. The present stud welding gun 14 may include a stud 26, a ferrule 28, a ferrule grip 30, a foot 32, legs 34, and a chuck adapter 38. Additionally, the exemplary stud welding gun 14 may include a trigger 40, the stud drive 15, and a handle 44. The stud drive 15 may include a main spring 45 and a solenoid 43 or other components adapted to produce a linear displacement or other displacement of the stud 26. The present stud welding gun 14 is a manual stud welding gun. Embodiments in accordance with the present technique may include an automatic production gun, a positioning device, an automatic fastener loading system, and/or a factory automation system, for example. The stud 26 may include conductive materials and have a generally cylindrical or otherwise elongated shape. Of course, the present technique is not limited to studs 26 with any particular shape. In some embodiments the stud 26 may include flux.

In the present stud welding gun 14, the ferrule 28 may be removably secured to the ferrule grip 30. The ferrule grip 30, in turn, may be removably secured to the foot 32, which may be held in spaced relation to the handle 44 by legs 34. Additionally, in the current embodiment, the stud 26 is removably coupled to the chuck 36, which is removably coupled to the chuck adaptor 38. Both the solenoid 43 and main spring 45 in the stud drive 15 may connect to the chuck adaptor 38 and to the handle 44. The solenoid 43 may be electrically connected to the control cable 20. The main spring 45 may be disposed around, in front of, behind, and/or in mechanical communication with the solenoid 43 so that operation of the solenoid 43 compresses or tensions the main spring 45. The solenoid 43 may include a coil of wire, such as 30 gauge wire, disposed about a cylindrical magnetic core.

In operation, when the ferrule 28 is pressed against the workpiece 16, a compressive force may be transmitted from the handle 44, through the legs 34, into the foot 32 and through the ferrule grip 30 to the ferrule 28. The compressive force from the handle 44 may press the ferrule 28 against the workpiece 16, thereby, in some embodiments, stabilizing the stud welding gun 14 at a static location on the workpiece 16. The present ferrule grip 30 may be removed from the foot 32 and replaced with a different sized ferrule grip 30 to accommodate different sized ferrules 28.

Once the ferrule 28 is pressed against the workpiece 16, various moving parts may position the stud 26 relative to the workpiece 16. For instance, the stud drive 15 may linearly position the stud 26 relative to the workpiece 16, as is depicted by arrows 46. In embodiments in which the stud drive 15 includes a solenoid 43 and a main spring 45, the positioning current transmitted through the control cable 20 from the power control unit 12 may energize the solenoid 43. The positioning current passing through a coil in the solenoid 43 may generate a magnetic flux that linearly drives the magnetic core. In some of these embodiments, the force generated by the solenoid 43 may compress or tension the main spring 45 and lift the stud 26. When the solenoid 43 is de-energized, the main spring 45 may relax and plunge the stud 26 back into the workpiece 16. Movement of the stud drive 15 may be transmitted to the stud 26 through the chuck 36 and the chuck adapter 38. In some embodiments, chuck 36 may be removed and replaced with different sized chucks 36 to accommodate different sized studs 26.

Several stages of an exemplary stud welding operation are depicted by FIGS. 3-6. As illustrated by FIG. 3, the stud 26 may be initially positioned at a specific location on the workpiece 16. In some embodiments, the stud 26 is pressed against the workpiece 16 by slightly compressing the main spring 45 in the stud drive 15. The ferrule 28 may also be pressed against the workpiece 16 in an area surrounding or near the stud 26. The present exemplary stud 26 includes a tip 48 that may contact the workpiece 16, a non-threaded portion 50, and a threaded portion 52. The exemplary stud 26 may be secured by the chuck 36.

Turning to FIG. 4, after locating the stud 26 on workpiece 16, a gap may be formed between the stud 26 and the workpiece 16. To form the gap, the solenoid 43 in the stud drive 15 may be energized at a first power level, thereby compressing the main spring 45 and lifting the chuck 36. As the chuck 36 lifts, the stud 26 may rise perpendicularly from the workpiece 16, as depicted by arrow 54. Once the stud 26 begins to lift, and inertial forces and/or static friction have been overcome, the solenoid 43 may be energized with a second, lower power level that generates heat at a lower rate than the first power level. In some embodiments, the lower power level may be carried by a smaller current. As the stud 26 is lifted, the stud 26 may slide within the ferrule 28, and the ferrule 28 may stay in contact with or near the workpiece 16. Alternatively, other embodiments may move the ferrule 28 or not include a ferrule 28, which is not to imply that other features discussed herein may not also be omitted in accordance with the present technique. Before, at approximately the same time, or after lifting 54 the stud 26, the welding system 10 may form an electric potential between the stud 26 and the workpiece 16 (hereinafter a source voltage, or Vₛ). A welding current may flow to/from the power control unit 12, through the weld cable 18, through the stud 26 and into/from the workpiece 16 across an arc 56. In the present embodiment, the arc 56 heats the metal in the stud 26 and/or the workpiece 16 and causes localized melting. The ferrule 28 may confine the heat and liquid metal near the tip 48 of the stud 26.

FIGS. 5 and 6 illustrate the completion of a successful stud welding operation. FIG. 5 depicts the re-application of the stud 26 to the workpiece 16. In the current embodiment, after a pool of molten metal 58 has been formed near the tip 48 of the stud 26, the stud drive 15 may plunge the stud 26 into the molten pool 58, as depicted by arrow 60. The illustrated solenoid 43 may be substantially de-energized from the second, lower power level, and the main spring 45 may resiliently plunge the stud 26 back into the workpiece 16. Finally, as depicted by FIG. 6, the molten pool 58 freezes, thereby forming a weld 62 between the stud 26 and the workpiece 16. At this point, the chuck 36 may be detached from the stud 26, and the ferrule 28 may be removed from the stud 26. The stud 26 may be generally permanently secured to the workpiece 16. Another stud 26 may be placed in the chuck 36, and the process depicted by FIGS. 3-6 may be repeated at another location on the workpiece 16.

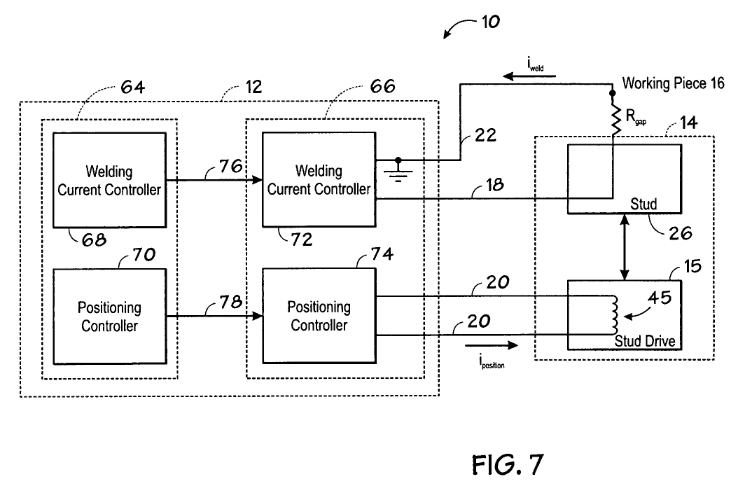

FIG. 7 is a diagrammatic representation of the welding system 10. The illustrated welding system 10 includes two circuits: one carrying welding current i_{weld} and one carrying positioning current iₚₒₛᵢₜᵢₒₙ. As discussed above, both circuits include portions of the power control unit 12 and the stud welding gun 14. The illustrated power source includes a controller 64 and a power source 66. In some embodiments, the controller 64 may include a welding current controller 68 and a positioning controller 70. The welding current controller 68 and positioning controller may be partially or entirely physically integrated, for instance in the form of a microcontroller, analog circuits, digital circuits, or a combination thereof.

The illustrated power source 66 may include a welding power source 72 and a positioning power source 74. Again, these components 72 and 74 may be partially or entirely integrated in some embodiments. In the present embodiment, the welding power source 72 may drive the welding current i_{weld}, such as a direct or alternating current, through the stud 26 and across an arc, represented in FIG. 7 by R_{gap}. The present welding power source 72 may be responsive to a welding control signal 76 from the welding current controller 68. For example, the illustrated welding power source 72 may output a pulse lasting less than 0.5, 0.75, 1, 1.25, or 1.5 seconds of welding current in response to a welding control signal or signals 76.

The illustrated positioning power source 74 may drive the positioning current iₚₒₛᵢₜᵢₒₙ. In the present embodiment, the positioning power source may be configured to output 0.5, 1, 2, 3, 4, 5, 6, 7, or 8 amperes or more of direct current or alternating current. In the current embodiment, the output of the positioning power source 74 may be controlled, entirely or in part, by a positioning control signal 78 from the positioning controller 70. To this end, the positioning controller 70, the positioning power source 74, or both may include components adapted to regulate the positioning current iₚₒₛᵢₜᵢₒₙ. For example, these components 70 and/or 74 may include a solid state switching device, such as an IGBT. In some embodiments, the power source 74 and positioning controller 70 may cooperate to pulse width modulate the positioning current iₚₒₛᵢₜᵢₒₙ. Alternatively, or additionally, the positioning current iₚₒₛᵢₜᵢₒₙ may be regulated via a current divider and a switching device, a lower power output of a transformer and a switching device, or other appropriate circuitry. The operation of the positioning controller 70 and positioning power source 74 is described below in reference to FIG. 8.

FIG. 8 illustrates the magnitude of the positioning current iₚₒₛᵢₜᵢₒₙ during an exemplary welding operation. In FIG. 8, time is show on the abscissa and current is shown on the ordinate. Initially, the positioning current iₚₒₛᵢₜᵢₒₙ may be at a rest current or resting power level. This stage may be referred to as a resting stage 80 and may generally correspond to the period before the trigger 40 of the stud welding gun 14 is pulled. During the resting stage 80, iₚₒₛᵢₜᵢₒₙ may be near zero current and the resting power level may be zero power.

At time tₛₜₐᵣₜ, which may generally correspond to a time at which the trigger 40 is pulled, the stud drive 15 may begin to lift the stud 26. When the positioning controller 70 determines that the trigger 40 has been pulled, the positioning controller 70 may transmit a positioning control signal 78 to the positioning power source 74. In response, the positioning power source 74 may output a start current or starting power level. This stage, when lifting is initiated, is generally referred to as a lift stage 82. The lift stage 82 may overcome, or begin to overcome, inertial forces and static friction forces associated with movement of the stud 26 from rest. During the lift stage 82, the positioning controller 70 may direct the positioning power source 74 to output a positioning current iₚₒₛᵢₜᵢₒₙ at a start current or power level, which may be greater than 0.5, 1, 2, 3, 4, 5, 6, 7, or 8 amperes or more of direct current or alternating current. In some embodiments, the lift stage 82 may last less than 800, 500, 300, 200, 100, 80, 60, 40, 30, 20, 10, 9, 8, 7, 6, or 5 milliseconds or less. During the lift stage 82, the forces and rate of heat generation output by the solenoid 43 may be large relative to the resting stage and subsequent stages. The end of the lift stage 82 may generally correspond with a substantial decrease or change in the positioning current iₚₒₛᵢₜᵢₒₙ.

After the lift stage 82, in the present embodiment, the stud drive 15 may continue lifting and/or at least substantially holding the stud 26 in an elevated position, as represented by the hold stage 84 of FIG. 8. During the hold stage 84, the positioning power source 74 may change iₚₒₛᵢₜᵢₒₙ to a hold current or power level. The hold current level may be substantially lower than the start current level. For instance, the hold current or power level may be less than 95%, 90%, 80%, 70%, 60%, 50%, 40%, 30%, 20%, or 10% of the start current level. In some embodiments, the hold current may be zero, for instance in embodiments employing a mechanical latch or catch to hold the stud 26 in an elevated position. Advantageously, lowering the positioning current i_{current} may lower rates of heat generation within the stud drive 15 and result in cooler operation of the stud welding gun 14. In certain embodiments, the rate of heat generation within the stud drive 15 during the hold stage 84 may be less than 95%, 90%, 80%, 70%, 60%, 50%, 40%, 30%, 20%, or 10% of the rate of heat generation during the lift stage 82. As depicted by FIG. 8, the present hold stage lasts for a substantial portion of a welding operation, such as more than 50%, 70%, or 90%.

Finally, iₚₒₛᵢₜᵢₒₙ may decrease to the rest current level, as depicted in the plunge stage 86 of FIG. 8. During the plunge stage 86, the positioning current iₚₒₛᵢₜᵢₒₙ may decrease to a rest current level, for instance zero current, and the rate of heat generation within the stud drive 15 may substantially decrease, for instance generally to zero. As iₚₒₛᵢₜᵢₒₙ decreases, the solenoid 43 my stop counteracting the main spring 45, and the main spring 45 may drive the stud 26 back into the workpiece 16, as explained above.

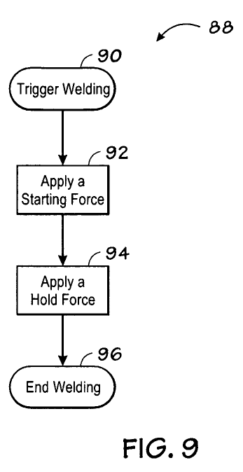

FIG. 10 depicts an exemplary welding method 88. The exemplary welding method 88 begins with trigger welding, as depicted by block 90. In some embodiments, trigger welding may include positioning a stud 26 on a workpiece 16 and/or pulling a trigger 40. After trigger welding, in the current embodiment, a starting force is applied to an electrode, such as the stud 26, as depicted by block 92 of FIG. 9. The magnitude and direction of the starting force may be selected to overcome inertial and static friction forces associated with initiating lifting the stud 26 from the workpiece 16.

Next, a hold force may be applied, as depicted by block 94. In some embodiments, the starting force may be released at substantially the same time the holding force is applied. The magnitude of the hold force 94 may be substantially less than the hold force, and the direction of the hold force may be generally the same as the starting force. In certain embodiments, the hold force may be applied by a various devices, such as the solenoid 43 energized at a holding current level or a mechanical latch in engagement with a portion of the solenoid 43, for example. In the present embodiment, the hold force 94 may be applied during a substantial portion of arcing between a stud 26 and a workpiece 16. Advantageously, applying a holding force that is smaller than the starting force may generate relatively little heat. For example, in embodiments that apply the holding force and starting force with the solenoid 43, the current through the solenoid 43 may be substantially decreased while applying a weaker holding force, thereby reducing the rate at which the solenoid 43 generates heat.

Finally, welding ends, as depicted by block 96. In some embodiments, the holding force 94 may cease to be applied, and a plunging force may be applied to the stud 26 or electrode. In certain embodiments, the plunging force may have a direction that is generally opposite the direction of the holding force. In the present embodiment, the plunging force is applied by the main spring 45.

1. A system, comprising:
a power source; and
a welding stud positioning controller coupled to the power source, wherein the welding stud positioning controller is configured to cooperate with the power source to output first, second, and third current levels one after another to a welding stud positioning device, wherein the first, second, and third current levels are different from one another.

2. The system of claim 1, wherein the power source comprises a direct current power source.

3. The system of claim 1, wherein the first current level is generally zero current.

4. The system of claim 1, wherein the third current level is less than 90% of the second current level.

5. The system of claim 1, wherein the first current level is approximately zero current, the second current level is greater than 1.5 amperes and the third current level is less than 70% of the second current level.

6. The system of claim 1, wherein the welding stud positioning controller comprises a solid state switch configured to switch at least between the second and third current levels.

7. The system of claim 6, wherein the solid state switch comprises an insultated gate bipolar transistor (IGBT).

8. The system of claim 1, wherein output at the third current level is pulse width modulated.

9. The system of claim 1, wherein the output at the second current level lasts less than 0.1 seconds.

10. The system of claim 1, wherein the output at the third current level lasts less than 2 seconds.

11. The system of claim 1, comprising a stud welding gun, an automatic stud loading system, a factory automation system, an stud gun positioning system, or any combination thereof.

12. A system, comprising:
a stud welding system, comprising:
a welding current control; and
a stud positioning control comprising stud lift, stud hold, and stud plunge stages, wherein the stud lift and stud hold stages have substantially different rates of heat generation.

13. The system of claim 12, wherein the stud lift stage has a substantially higher rate of heat generation than the stud hold stage.

14. The system of claim 12, comprising a power control unit, wherein the stud positioning control and the welding current control are disposed in the power control unit.

15. The system of claim 12, comprising a stud welding gun having a solenoid, wherein the stud lift stage is configured to energize the solenoid.

16. The system of claim 15, comprising a spring disposed in opposition to the solenoid, wherein the stud plunge state is configured to at least substantially de-energize the solenoid.

17. A method, comprising:
lifting a welding stud with a first level of power; and
holding or further lifting the welding stud with a second level of power different from the first level of power.

18. The method of claim 17, wherein the first level of power, the second level of power, or both are levels of electrical power.

19. The method of claim 17, wherein lifting a welding stud with a first level of power lasts less then 35 milliseconds.

20. The method of claim 17, wherein the second level of power is substantially less than the first level of power.
